(19) United States
(12) Patent Application Publication
(10) Pub. No.: US 2006/0275074 A1
(43) Pub. Date: Dec. 7, 2006

(54) Linkage pin and method of manufacturing the same

(76) Inventors: Rene Guinard, Chantesse (FR); Alain Pizon, Grenoble (FR); Jean-Francois Villard, St. Etienne de St. Geoirs (FR)

Correspondence Address: CATERPILLAR INC.;100 N.E. ADAMS STREET, PATENT DEPT., PEORIA, IL, 616296490, US

(21) Appl. No.: 11/145,062

(22) Filed: Jun. 3, 2005

(51) Int. Cl. B25G 3/28

(52) U.S. Cl. 403/355

(57) ABSTRACT

Linkage pins are commonly used to join two members to provide a rigid connection or to function as a pivot point. They are often manufactured from piece parts that ideally are provided with a protective coatings before assembly. The joint needs to be able to withstand the harsh environments linkage pins may be used in and the joining process must cause minimal disturbance to the coating to prevent it from having to be reapplied after manufacturing. The present invention discloses a method and linkage pin including a mechanical deformation to form a joint. The components are arranged in a particular orientation to provide optimum durability by aligning them in a direction dependent on the direction of the flexing caused by the forces acting upon the pin.

### TECHNICAL FIELD

The present invention relates to a linkage pin and a manufacturing method for the same. More specifically it relates to a linkage pin for connecting two or more members of a work machine.

### BACKGROUND

Work machines such as tracked loaders, excavators and the like commonly use metal pins to connect two sections of the machine together. This may be done for several reasons, such as to create a pivot arrangement or to allow simplified removal and fitting of components like hydraulic rams which often are specifically provided with eye ends to receive such pins. Pins like this are often exposed to severe and a wide range of differing loads such as torsional, longitudinal and lateral loading. To maintain the pin in the desired position a common form of retention is to provide a lever arm which is typically a metal plate fixed perpendicularly to the pin. One end of the lever arm is fixed to the pin whilst another end forms a portion that may be bolted or clamped to prevent displacement of the lever arm and hence the pin. The lever arm may be fixed so as to substantially prevent any movement, but if preferred some degree of movement may be allowed. Pins having a construction as described often fail prematurely, especially the connection between the lever arm and the pin being prone to fatigue.

It is often preferred to provide the components with a surface treatment such as an anti-corrosion protective coating. The manufacturing process of such pins would be greatly improved if the individual components receive such treatment before they are joined together, but commonly used processes such as welding damage the coating and require the assembly to be recoated after the operation.

The present invention aims to overcome one or more of the above disadvantages.

### SUMMARY OF THE INVENTION

According to a first aspect of the present disclosure there is provided a linkage pin having a pin with an elongated boss at a first end whereby the elongated boss defines a first longitudinal axis. The linkage pin further has a lever arm which is provided with an aperture corresponding to the elongated boss whereby the lever arm defines a second longitudinal axis. The pin is fixedly connected to the lever arm such that the elongated boss is located in the corresponding aperture and that the first and second longitudinal axes are substantially parallel to each other.

Another aspect of the present disclosure is a method for manufacturing a linkage pin wherein the following steps are present:
a) forming a pin having an elongated boss at a first end whereby the elongated boss defines a first longitudinal axis,
b) forming a lever arm and providing the lever arm with an aperture that corresponds to the elongated boss whereby the lever arm defines a second longitudinal axis,
c) positioning the elongated boss in the corresponding aperture,
d) fixing the pin to the lever arm such that the first and second longitudinal axes are substantially parallel to each other.

A third aspect of the disclosure provides a linkage pin having a pin with a first longitudinal axis and an elongated boss at a first end whereby the elongated boss defines a second longitudinal axis. The linkage pin further has a lever arm provided with an aperture corresponding to the elongated boss whereby the lever arm defines a third longitudinal axis. The pin and second lever arm are fixedly connected whereby the elongated boss is positioned within the aperture and the first and third longitudinal axes form a virtual angle α. The pin is adapted to be subjected to forces in a direction that primarily influence angle α by having the second and third longitudinal axes substantially parallel to each other.

Other features of the present disclosure will be apparent from the following description and the accompanying drawings.

### BRIEF DESCRIPTION OF THE DRAWINGS

FIG. 1 is a schematic isometric view of a linkage pin according to the current invention.

FIG. 2 is an exploded view of the linkage pin shown in FIG. 1.

FIG. 3 shows a schematic cross-sectional view of the pin from FIGS. 1 and 2 applied to a typical linkage arrangement.

FIG. 4 shows an exploded partial end representation of interfaces of a lever arm and a pin according to the present invention.

FIG. 5 is a part representation of an assembled pin and lever arm from FIG. 4.

### DETAILED DESCRIPTION

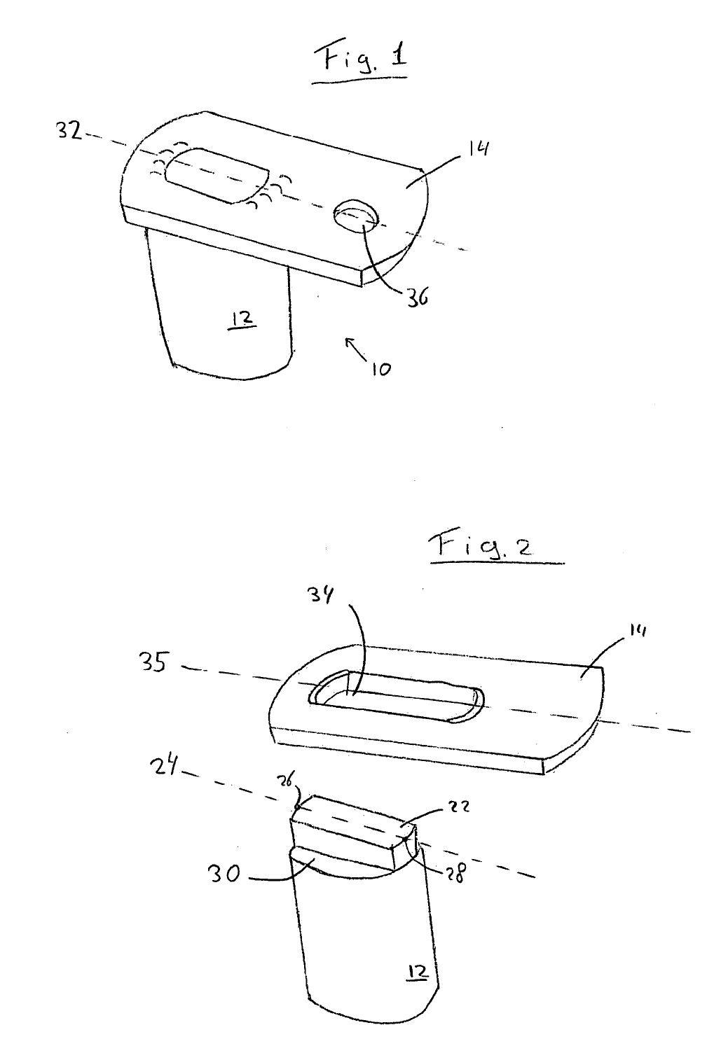

With reference to FIGS. 1, 2 and 3, a linkage pin 10 has a pin 12 and a lever arm 14. Pin 12 is shown as a substantially cylindrical body but may also have a non-cylindrical body and may be shaped irregular such as stepped or tapered if preferred. Pin 12 defines a longitudinal axis 13. FIG. 3 shows a typical application of linkage pin 10, wherein it forms a link between a first member 16 and a second member 18. The first and second members 16 and 18 may be for example loader arm segments of a work machine such as an excavator or the like. Where the linkage pin 10 is designed to function as a pivot point for the two members 16 and 18 the pin 12 will be at least partially cylindrical to accommodate the rotational movement of the first member relative to the second member. The pin 10 may however still be stepped or vary in diameter along its length if that is suitable for the application. Either or both of the members 16 and 18 may be provided with some kind of load bearing and wear part arrangement such as a bushing 20.

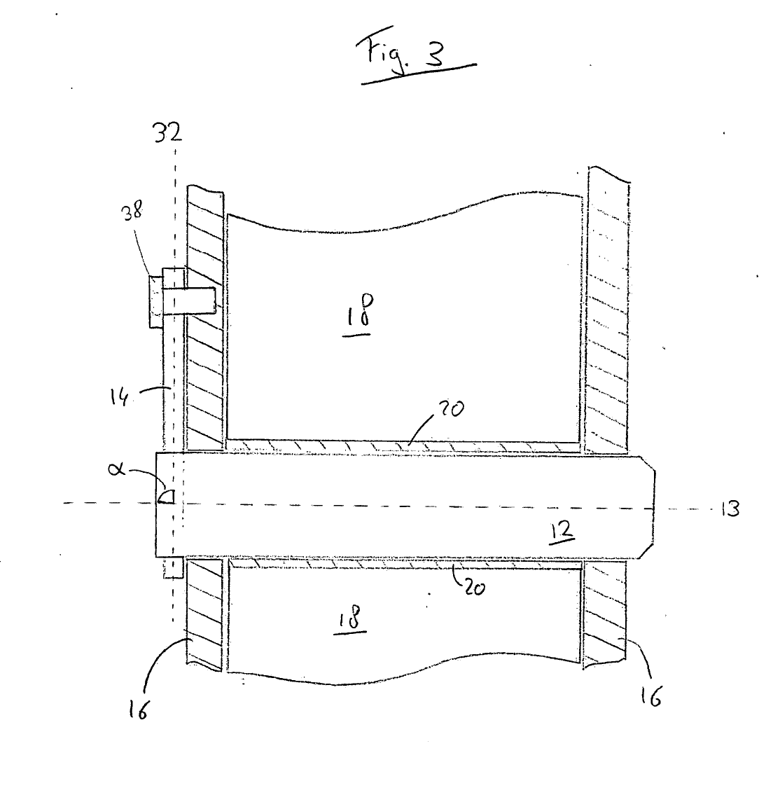

With reference to FIG. 2, the pin 12 is at one end provided with a projection such as boss 22 with a longitudinal axis 24. This boss may be formed by milling two radially opposite sides of one end of the pin 12 such that an elongated projection remains. The end portions 26 and 28 of the boss which intersect the longitudinal axis 24 may be left intact so the length of the boss 22 is substantially identical to the diameter of the pin 12, but alternatively the ends may be machined to form for example a straight edge. Providing the pin 12 with the boss 22 also leads to the formation of a shoulder 30 on the pin 12. The end of the pin 12 opposite to the end provided with boss 22 may be tapered to facilitate installation.

The lever arm 14 may be a flat steel plate in a multitude of possible shapes and defines a longitudinal axis 32. Lever arm 14 is furthermore provided with an aperture such as slot 34. Slot 34 defines a longitudinal axis 35 which is substantially parallel to and may even coincide with the axis 32 of the lever arm 14. Of course it is to be understood that due to manufacturing tolerances a perfect parallelism may not be achieved. In one embodiment, the lever arm 14 may be provided with a second aperture 36 for receiving a fastener such as bolt 38.

The longitudinal axis 32 of lever arm 14 and the longitudinal axis 13 of pin 12 may lie in the same plane or in different planes but appear to intersect at a virtual angle α when seen from the side as shown in FIG. 3. In one embodiment α is substantially 90°, but other angular relationships may be adopted if preferred. The lever arm 14 and the pin 12 are connected by locating the boss 22 in the slot 34. The dimensions of both the boss 22 and the slot 34 are matched so as to provide a good fit. The lever arm 14 and the pin 12 are then engaged in a permanent or semi-permanent fixation by an operation such as glueing, welding, swaging or by using a fastener such as a setscrew.

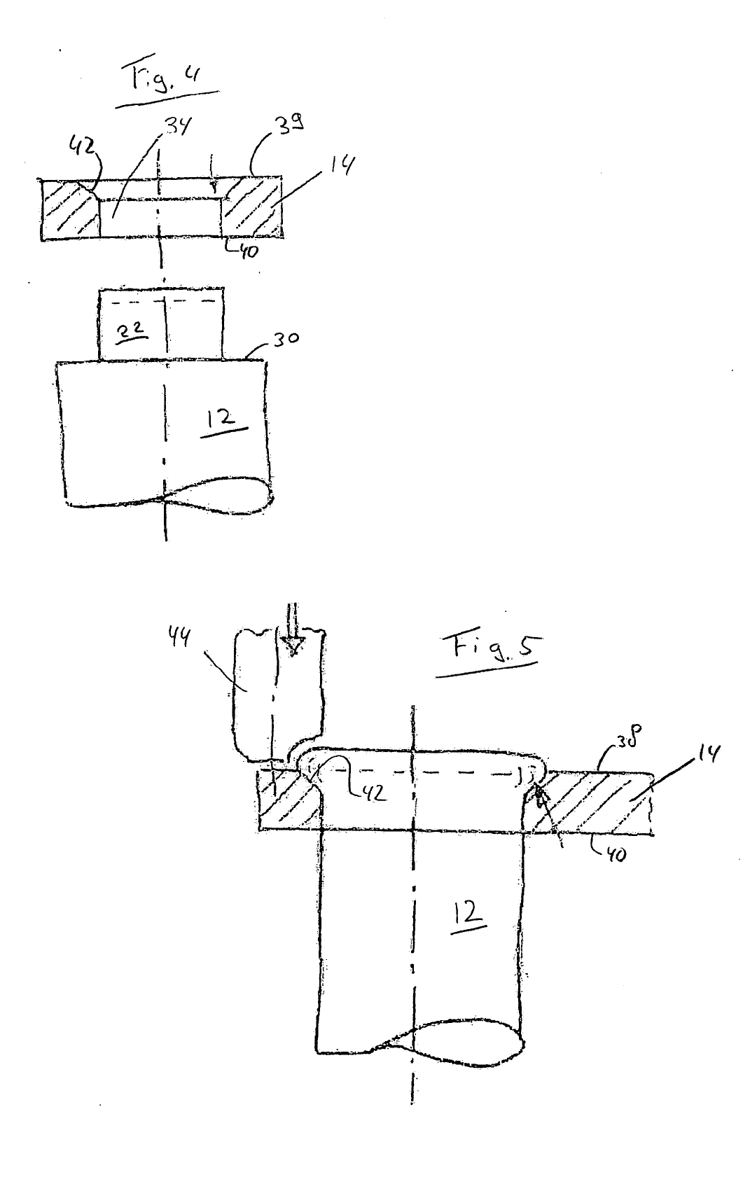

FIGS. 4 and 5 show one embodiment for achieving a fixation of the lever arm 14 and the pin 12. The lever arm 14 has a first surface 39 and a second surface 40. The height of the boss 22 as measured from the shoulder 30 is greater than the distance between the surfaces 39 and 40. With the lever arm 14 placed around the boss 22 such that the surface 40 abuts the shoulder 30, the boss 22 then extends into and beyond the surface 39. The part of the boss 22 that extends beyond the surface is then mechanically deformed by a process such as swaging with a swaging tool 44 to create a retaining portion.

As can be seen from FIGS. 4 and 5 the contact area between the pin 12 and the lever arm 14 may be increased by providing at least part of the circumference of the slot 34 with a chamfered edge 42. This will allow a greater portion of the pin 12 to be deformed whilst attaining a more elaborate shape so as to form a stronger joint.

### INDUSTRIAL APPLICABILITY

The pin 12 and the lever arm 14 may be manufactured separately. Once all the preferred features have been provided to both the pin 12 and the lever arm 14, both may undergo a protective treatment to shield them from corrosion or other types of damage being either functional or aesthetic. The treatment may include a process such as for example zinc-plating or phosphate coating. Once treated, the pin 12 and the lever arm 14 are assembled and a swaging process may be applied to form a permanent fixation. The elongated shapes of both the slot 34 and the boss 22 combined with the swaged end portion of the pin 12 prevent the two parts from moving relatively to one another. Swaging the components results in no or minimal disturbance of the protective coating and does therefore not require a coating to be reapplied after the joining operation.

The pin may thereafter be assembled into a work machine such as described earlier. The aperture 36 may be aligned with a threaded portion in the first member 16 and an at least partially threaded fastener 38 may be positioned in the aperture 36 and threadingly engaged with the first member 16. This will retain the pin in its desired position and thus prevents lateral movement or rotation of the pin relative to the member 16. Alternative retention means may of course be applied. It is for example known in the art to apply a semi-fixed retention method wherein the pin 10 may be allowed a certain degree of rotational movement. This could for example be achieved by providing the lever arm with an oversize aperture and providing a spacer and washer arrangement whereby the pin 10 can rotate for a limited amount. Another alternative retention means known in the art is to provide the surface 16 with one or more projections to which a retainer plate can be fixed so as to form a ‘cage’ in which the lever arm can be locked or semi-locked.

Once assembled into a work machine, the pin 10 is exposed to a wide range of forces. For example, the pin 10 may be used in applications where the pin 10 provides a hinge function, i.e. it is fixed in a position relative to member 16 whilst member 18 can pivot around the pin 10. If lubrication between the surfaces of the pin 10 and the member 18 or its bushing 20 is insufficient, the friction may increase even to the point where the pin 10 and the bushing 20 are cold-welded together. When the two members are operated to pivot relative to one another and friction is high a torsional force is generated in the pin 10 as one end is restraint by the lever arm 14. This torsional force is counteracted by the non-cylindrical or elongated shape of both the slot 34 and the boss 22.

In one embodiment a plurality of external forces acting in the same or different directions act upon the pin 10. One force or a particular set of forces are identified as being the so-called primary forces because they are the main contributor to causing flexing of the lever arm 14 relative to the pin 12, or vice versa. Angel α may be described as the angle between the pin 10 and the lever arm 14 that lies substantially in or parallel to the plane of the primary forces acting on the pin. For example, the primary forces may act on the pin 10 or the lever arm 14 in a manner to increase or decrease the angle a α. By using a pin 10 as described, and aligning the longitudinal axes of boss 22, and slot 34 with the direction of the flexing, the robustness of the joint between the pin 12 and lever arm 14 is significantly increased.

Although embodiments of this invention have been described herein, improvements and modifications may be incorporated without departing from the scope of the following claims.

What is claimed is:

1. A linkage pin comprising;
a pin having an elongated boss at a first end, said elongated boss defining a first longitudinal axis,
a lever arm provided with an aperture corresponding to said elongated boss, said lever arm defining a second longitudinal axis,
said pin being fixedly connected to said lever arm such that said elongated boss is located in said corresponding aperture and said first and second longitudinal axes are substantially parallel to each other.

2. A linkage pin according to claim 1, wherein said lever arm has a first side and a second side, said boss protruding through said aperture from said first side and extending beyond said second side.

3. A linkage pin according to any of the preceding claims, wherein said pin is provided with a shoulder and said lever arm abuts said shoulder.

4. A linkage pin according to claim 2, wherein said connection between said pin and said lever arm is formed by mechanical deformation of at least a portion of said boss.

5. A linkage pin according to claim 4, wherein said aperture has a chamfered circumference at said second side of said lever arm and said boss is at least partially deformed to correspond to said chamfered circumference.

6. A linkage pin according to claim 1, wherein said connection is formed by a welding process.

7. A linkage pin according to claim 1, wherein said connection is formed by an adhesive.

8. A method for manufacturing a linkage pin comprising the following steps;
a) forming a pin having an elongated boss at a first end, said elongated boss defining a first longitudinal axis,
b) forming a lever arm and providing said lever arm with an aperture that corresponds to said elongated boss, said lever arm defining a second longitudinal axis,
c) positioning said elongated boss in said corresponding aperture,
d) fixing said pin to said lever arm such that said first and said second longitudinal axes are substantially parallel to each other.

9. A method for manufacturing a linkage pin according to claim 8, wherein said process comprises a step of providing said aperture with a chamfered circumference.

10. A method for manufacturing a linkage pin according to any of claims 8 to 9, wherein step d) comprises a mechanical deformation of at least a portion of said boss.

11. A method for manufacturing a linkage pin according to claim 10, wherein said mechanical deformation results in said at least a portion of said boss corresponding to at least a part of said chamfered circumference.

12. A method for manufacturing a linkage pin according to claim 8, wherein after step c) said boss protrudes through and extends beyond said slot.

13. A linkage pin comprising;
a pin having an elongated boss at a first end, said elongated boss defining a first longitudinal axis,
a lever arm provided with an aperture corresponding to said elongated boss, said lever arm defining a second longitudinal axis,
said pin and said second lever arm being fixedly connected whereby said elongated boss is positioned within said aperture,
said pin being adapted to be subjected to forces in a direction, whereby said direction of said forces, and said first longitudinal axis are all substantially parallel to each other.
